(19) United States
(12) Patent Application Publication
(10) Pub. No.: US 2008/0079730 A1
(43) Pub. Date: Apr. 3, 2008

(54) CHARACTER-LEVEL FONT LINKING

(75) Inventors: Ye Zhang, Beijing (CN); Qisheng Zhao, Beijing (CN); Pung Pengyang Xu, Sammamish, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: MICROSOFT CORPORATION, Redmond, WA (US)

(21) Appl. No.: 11/537,055

(22) Filed: Sep. 29, 2006

(51) Int. Cl. G06T 11/00

(52) U.S. Cl. 345/468

(57) ABSTRACT

A “Character-Level Font Linker” provides character-level linking of fonts via Unicode code-point to font mapping. A lookup table is used to identify glyph-level support for runs of particular characters on a Unicode code-point basis for relative to a set of available fonts. This lookup table enables automatic selection of one or more specific fonts for rendering one or more runs of characters comprising a text string. The lookup table is constructed offline by automatically evaluating glyphs comprising a set of common or default fonts. The table is then used for automatically selecting fonts for rendering text strings. Alternately, the lookup table is generated (or updated) locally to include some or all locally installed fonts. Finally, in another embodiment, if no supporting font is identified in the table for a particular character, the system automatically downloads the necessary glyph from one or more remote servers.

### BACKGROUND

1. Technical Field

The invention is related to font mapping, and in particular, to a technique for providing fine granularity font selection via character-level font linking as a function of Unicode code-point to font mapping.

2. Related Art

As is well known to those skilled in the art, the Unicode standard (International Standard ISO/IEC 10646) supports encoding forms that use a common repertoire of characters. These encoding forms allow for encoding as many as a million unique characters to provide full coverage of all modern and historic scripts of the world, as well as common notational systems (including punctuation marks, diacritics, mathematical symbols, technical symbols, arrows, dingbats, etc.). For example, these scripts include European alphabetic scripts, Middle Eastern right-to-left scripts, and Asian scripts which include complex characters such as Japanese Hiragana and Chinese ideographs, to name only a few.

In general, a “code-point” is the number or index that uniquely identifies a particular Unicode character. The complete set of Unicode characters is intended to represent the written forms of the world's languages, historic scripts, and symbols used for academic and other reasons. To keep character coding simple and efficient, the Unicode standard assigns each character (“a,” “b,” “c,” “ü,” “ñ,” etc.) from every major language and/or alphabet a unique numeric value and name.

The difference between identifying a code-point and rendering it on screen or paper is crucial to understanding the Unicode Standard's role in text processing. In particular, the character identified by a Unicode code-point is an abstract entity, such as “LATIN CHARACTER CAPITAL A” or “BENGALI DIGIT 5.” The corresponding mark rendered on screen or paper, called a “glyph,” is a visual representation of the specified character.

However, the Unicode Standard does not define glyph images. The standard defines how characters are interpreted, not how the corresponding glyphs are rendered. The software or hardware-rendering engine of a computer is responsible for the appearance of the characters on the screen. In other words, a “glyph” is a picture for displaying and/or printing a visual representation of a character identified by a code-point within the Unicode codespace.

A “font” is a set of glyphs that typically represent some subset of the Unicode codespace, with stylistic commonalities between those glyphs in order to achieve a consistent appearance when many such glyphs are combined to render a text string. However, when an application attempts to display and/or print a visual representation of a text character using a particular font, if one or more characters are not supported by that font, the application rendering the text will generally render those unsupported characters as “white boxes” such as “□□□□□□□□□□.”

Conventional font linking schemes are used in an attempt to solve the “white box” problem by providing automatic font switching based on Unicode code-point values of each character in a text stream to be rendered. For example, with conventional font linking, if a font “W” is applied to characters from a Unicode range not supported by the “W” font, then predefined virtual links to other fonts (e.g., font sets “X,” “Y” and “Z”) are used in an attempt to find a font that supports the desired Unicode characters.

As a result, once the font linking relationship has been defined, whenever a user (or an application) applies font set “W” to text data, the actual result will be a combined coverage of the text data from several different linked font sets (“W,” “X,” “Y,” “Z” . . . ), depending upon the Unicode characters in the text data. In other words, the basic idea is that some fonts are linked in a chain, and if a given character can't be found in the base font of that chain, the application will search the next font down the line and so on, until the desired character is found. Unfortunately, this type of dynamic font linking tends to be computationally expensive, as an application using conventional font linking schemes needs to search through the linked font chain to identify a font that supports a particular character every time any character is not supported by the first font in the chain. Further, if the particular character is not supported by any of the fonts in the linked chain of fonts, then the result is generally a “white box” rendering for displaying that character, as described above.

Typical applications generally rely on header information included in the font file to tell the application whether that particular font supports a particular script. Unfortunately, most fonts identify themselves as supporting a particular script even in the case where that font only includes a subset of the desired script. As a result, an application examining a font header may incorrectly assume that a font supports a particular character with a corresponding glyph, even if the font is missing that character of the corresponding script. Consequently, for many scripts, such as Cyrillic, Hebrew, Greek and Coptic, Latin Extended-B, Spacing Modifier Letters, IPA Extensions, Latin-1 Supplement, etc., an application rendering particular characters may render as many as 20% to 40% of those characters as white boxes, depending upon the font selected to render particular characters for a particular script.

For example, during parsing of a text string, a typical application will generally segment that string into runs of characters corresponding to one or more uniform script ID's (SID's) which identify the script (such as Latin, Cyrillic, Hebrew, etc.) needed to render each run of the text string. The corresponding SID information is then generally stored in a markup tree. Then, during font selection for each run, the application first selects either the default or user defined font face name (i.e, “Time New Roman,” “Arial,” etc.), then calculates the font's SID (or SIDs in the case where a font supports multiple scripts). If the selected font's SID covers run's SID, then the application will assume that the selected font has all glyphs for that run and that font will be used to render the corresponding characters. However, in the case where the SID of the selected font does not cover the SID of the current text run, the application will examine the next linked font to determine whether its SID covers the current text run. This process will generally continue either until a font SID matches the run SID, or until the end of the linked fonts is reached.

Unfortunately, in the case where a font's SID covers run's SID, then the application will assume that the current font has all glyphs for that run and use this font. As noted above, there is no guarantee that the font has a complete set of glyphs for every character of the script just because the font's SID covers the run's SID. For example, the header information included in the “Times New Roman” font shipped with Windows™ XP indicates that it supports the Latin Extension-B script; however, this Times New Roman font actually supports only a fraction of the characters in that script. As a result, the above-described “white box” character rendering problem frequently occurs with some of the less common characters associated with the Latin Extension-B script.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A “Character-Level Font Linker,” as described herein, provides character-level linking of fonts via Unicode code-point to font mapping. In contrast to conventional dynamic font linking schemes which generally identify whether a font provides nominal support for a particular script (Latin, Cyrillic, Hebrew, Greek and Coptic, Japanese Hiragana, Latin Extended-B, Spacing Modifier Letters, IPA Extensions, Latin-1 Supplement, etc.), the Character-Level Font Linker operates based on a predefined lookup table, or the like, which identifies glyph-level support for particular characters on a Unicode code-point basis for each of a set of available fonts. In other words, the lookup table provided by the Character-Level Font Linker includes a Unicode code-point to font map that allows an immediate determination as to 1) whether a particular font supports a particular character with a corresponding glyph, or 2) given a particular character, which particular font(s) supports it with corresponding glyph.

In general, the Character-Level Font Linker begins operation by parsing a text string to be rendered and/or printed to identify runs of characters that have glyph-level support for all characters in the run with respect to a particular font. Glyph support for particular characters is determined by comparing the Unicode code-point of each character to its corresponding entry in the lookup table.

Character runs are delimited by examining the characters in the text string relative to the lookup table to find a contiguous set of one or more characters supported by a single font (beginning with a user specified or preferred font called default font hereafter) that provides a glyph for each character in the run. Once an initial supporting font (i.e., a font having glyph support) is identified for the first character in the run, each successive character is examined to determine whether the initial supporting font supports the next character in the string with a corresponding glyph. As soon as an unsupported character is identified with respect to the initial supporting font or a character that again can be supported by the default font (this insures the text can be rendered using the default font as much as possible), the current run is terminated, and a new run is begun. The lookup table is then consulted for the new run to identify a subsequent font that supports the current character and one or more subsequent characters, This process continues until all character runs have been identified and assigned supporting fonts.

Finally, once all of the runs have been identified and assigned supporting characters from corresponding fonts, the text string is rendered and/or printed by using conventional techniques for displaying and/or printing the glyphs corresponding to the characters in the text string using the fonts assigned to each run.

In view of the above summary, it is clear that the Character-Level Font Linker described herein provides a unique system and method for ensuring that characters in a text string will be rendered with as few “white boxes” as possible by ensuring that fonts assigned to character runs segmented from the text string provide glyphs for each character in each run. In addition to the just described benefits, other advantages of the Character-Level Font Linker will become apparent from the detailed description which follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 is a general system diagram depicting a general-purpose computing device constituting an exemplary system for implementing a Character-Level Font Linker, as described herein.

FIG. 2 illustrates an example of a subset of the Times New Roman font showing a large number of “white boxes” (unsupported characters) existing within the code-point range of 0180 to 01FF (corresponding to a subset of the Unicode “Latin Extended-B” script).

FIG. 3 illustrates an exemplary architectural system diagram showing exemplary program modules for implementing the Character-Level Font Linker.

FIG. 4 illustrates an exemplary system flow diagram for implementing various embodiments of the Character-Level Font Linker, as described herein.

### DETAILED DESCRIPTION

In the following description of various embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 General Definitions:

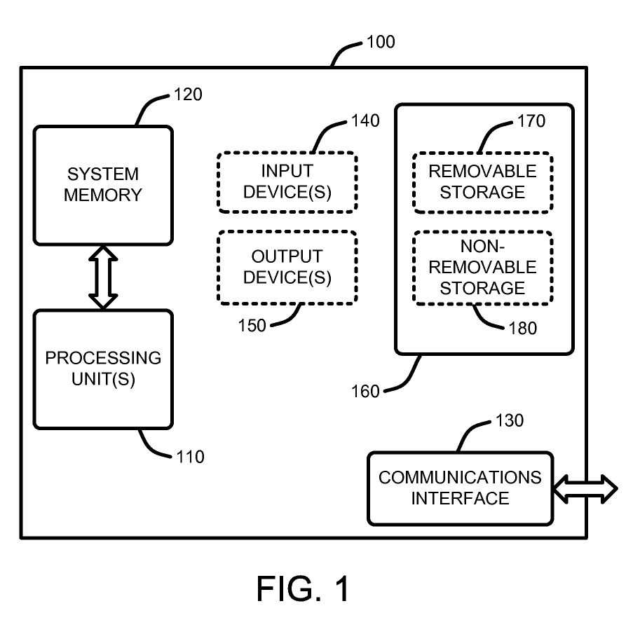

The definitions provided below are intended to be used in understanding the description of the “Character-Level Font Linker” provided herein. Further, as described following these definitions, FIG. 1 illustrates an example of a simplified computing environment on which various embodiments and elements of the Character-Level Font Linker may be implemented The terms defined below generally use their commonly accepted definitions. However, for purposes of clarity, the definitions for these terms are reiterated in the following paragraphs:

1.1 Character: The smallest component of written language that has a semantic value. A “character” generally refers to the abstract meaning and/or shape, rather than a specific shape. In the context of the Character-Level Font Linker, characters are defined in terms of their Unicode code-point.

1.2 Glyph: The term “glyph” is a synonym for glyph image. In rendering, displaying and/or printing a particular Unicode character, one or more glyphs are selected from a font (or fonts) to depict that particular character.

1.3 Font: A “font” is a set of glyphs for rendering particular characters. The glyphs associated with a particular font generally have stylistic commonalities in order to achieve a consistent appearance when rendering, displaying and/or printing a set of characters comprising a text string. Examples of well known fonts include “Times New Roman” and “Arial.”

1.4 Script: A “script” is a unique set of characters that generally supports all or part of the characters used by a particular language. Typically, many fonts will support (at least in part) one or more scripts. Examples of scripts include Latin, Cyrillic, Hebrew, Greek, Latin Extended-B, etc., to name only a few.

While scripts support characters used by a particular language, scripts are not generally mapped in a one-to-one relationship with particular languages. For example, the Japanese language generally uses several scripts, including Japanese Hiragana, while the Latin script is used for supporting many languages, including, for example, English, Spanish, French, etc., each of which may use particular characters unique to those particular languages.

Further, fonts generally include header information that indicates whether the font provide a nominal support for a particular script. However, an indication of script support by a particular font is no guarantee that the particular font will actually support all of the characters of a particular script with glyphs for every character intended to be included in that script.

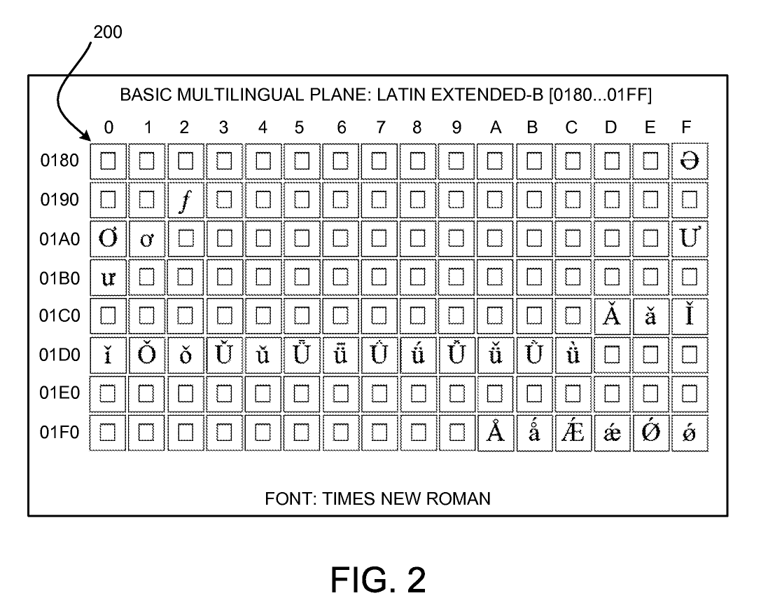

For example, FIG. 2 illustrates a subset of the Latin Extended-B script (showing only those code-points in the range of 0180 to 01FF hex) for the conventional “Times New Roman” font. As illustrated by FIG. 2, a number of glyphs corresponding to specific code-points are shown as “white boxes” when the font doesn't have glyphs to support the characters corresponding to those code-points.

A particular example of this problem is Unicode code-point 0180 (element 200 for FIG. 2) for the Times New Roman font. Code-point 0180 here should provide a glyph for “Latin small letter B with stroke” in the Latin Extended-B script. However, as illustrated by FIG. 2, a white box (element 200 for FIG. 2) is displayed for this glyph since the Times New Roman font does not fully support the Latin Extended-B script with respect to the code-point of that character. It should be noted that many fonts, including the Times New Roman font, include header information that indicate support for the Latin Extended-B script even though there may be a number of “holes” (white boxes) in this support.

Script ID (“SID”): A “SID” is used to provide a Unicode identification of a script which identifies the script (Latin, Cyrillic, Hebrew, etc.) needed to render each run of a text string. Generally, these SIDs are used to determine whether a particular script is supported

Run: A “run” is a run of contiguous characters extracted from a text string that uses the same font and/or formatting.

2.0 Exemplary Operating Environment:

FIG. 1 illustrates an example of a simplified computing environment on which various embodiments and elements of a “Character-Level Font Linker,” as described herein, may be implemented. It should be noted that any boxes that are represented by broken or dashed lines in FIG. 1 represent alternate embodiments of the simplified computing environment, as described herein, and that any or all of these alternate embodiments, as described below, may be used in combination with other alternate embodiments that are described throughout this document.

At a minimum, to enable a computing device to implement the “Character-Level Font Linker” (as described in further detail below), the computing device 100 must have some minimum computational capability and either a wired or wireless communications interface 130 for receiving and/or sending data to/from the computing device, or a removable and/or non-removable data storage for retrieving that data.

In general, FIG. 1 illustrates an exemplary general computing system 100. The computing system 100 is only one example of a suitable computing environment and is not intended to suggest any limitation as to the scope of use or functionality of the invention. Neither should the computing system 100 be interpreted as having any dependency or requirement relating to any one or combination of components illustrated in the exemplary computing system 100.

In fact, the invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer in combination with various hardware modules. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

For example, with reference to FIG.1, an exemplary system for implementing the invention includes a general-purpose computing device in the form of computing system 100. Components of the computing system 100 may include, but are not limited to, one or more processing units 110, a system memory 120, a communications interface 130, one or more input and/or output devices, 140 and 150, respectively, and data storage 160 that is removable and/or non-removable, 170 and 180, respectively.

The communications interface 130 is generally used for connecting the computing device 100 to other devices via any conventional interface or bus structures, such as, for example, a parallel port, a game port, a universal serial bus (USB), an IEEE 1394 interface, a Bluetooth™ wireless interface, an IEEE 802.11 wireless interface, etc. Such interfaces 130 are generally used to store or transfer information or program modules to or from the computing device 100.

The input devices 140 generally include devices such as a keyboard and pointing device, commonly referred to as a mouse, trackball, or touch pad. Such input devices may also include other devices such as a joystick, game pad, satellite dish, scanner, radio receiver, and a television or broadcast video receiver, or the like. Conventional output devices 150 include elements such as a computer monitors or other display devices, audio output devices, etc. Other input 140 and output 150 devices may include speech or audio input devices, such as a microphone or a microphone array, loudspeakers or other sound output device, etc.

The data storage 160 of computing device 100 typically includes a variety of computer readable storage media. Computer readable storage media can be any available media that can be accessed by computing device 100 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules, or other data.

Computer storage media includes, but is not limited to, RAM, ROM, PROM, EPROM, EEPROM, flash memory, or other memory technology; CD-ROM, digital versatile disks (DVD), or other optical disk storage; magnetic cassettes, magnetic tape, magnetic disk storage, hard disk drives, or other magnetic storage devices. Computer storage media also includes any other medium or communications media which can be used to store, transfer, or execute the desired information or program modules, and which can be accessed by the computing device 100. Communication media typically embodies computer readable instructions, data structures, program modules or other data provided via any conventional information delivery media or system.

The computing device 100 may also operate in a networked environment using logical connections to one or more remote computers, including, for example, a personal computer, a server, a router, a network PC, a peer device, or other common network node, and typically includes many or all of the elements described above relative to the computing device 100.

The exemplary operating environments having now been discussed, the remaining part of this description will be devoted to a discussion of the program modules and processes embodying the “Character-Level Font Linker.”

3.0 Introduction:

A “Character-Level Font Linker,” as described herein provides character-level linking of fonts via Unicode code-point to font mapping. In contrast to conventional dynamic font linking schemes which generally identify whether a font provides nominal support for a particular script (Latin, Cyrillic, Hebrew, Greek and Coptic, Japanese Hiragana, Latin Extended-B, Spacing Modifier Letters, IPA Extensions, Latin-1 Supplement, etc.), the Character-Level Font Linker operates based on a predefined lookup table, or the like, which identifies glyph-level support for particular characters on a Unicode code-point basis for each of a set of available fonts. In other words, the lookup table provided by the Character-Level Font Linker includes a Unicode code-point to font map that allows an immediate determination as to 1) whether a particular font supports a particular character with a corresponding glyph, or 2) given a particular character, which particular font(s) supports it with corresponding glyph.

3.1 System Overview:

As noted above, the Character-Level Font Linker described herein provides a system and method for ensuring that characters in a text string will be rendered with as few “white boxes” as possible by ensuring that fonts assigned to character runs segmented from a text string provide glyphs for each character in each run. In addressing such problems, the Character-Level Font Linker operates either by itself, or in combination with conventional font identification or font assignment systems.

For example, in the case where the Character-Level Font Linker operates in combination with existing font assignment systems, the conventional font selection system will select a default font for rendering one or more runs of text. Then, given this default font, the Character-Level Font Linker will begin an examination of whatever default font is selected for rendering a particular text string to determine whether that selected font includes actual glyphs to support each character of the current text run. If the run is supported with actual glyphs, the Character-Level Font Linker does not change the font assigned to those characters. However, in the case where the Character-Level Font Linker determines that the assigned font can not support one ore more characters of any runs with glyphs, then the Character-Level Font Linker operates as described herein to assign a new font or fonts to those characters prior to rendering, displaying, or printing those characters.

As noted above, the Character-Level Font Linker operates either by itself, or in combination with conventional font identification or font-linking systems. However, for purposes of explanation, the remaining detailed description will address the standalone case for font selection, as the operation of the combination case should be clear to those skilled in the art in view of the detailed description provided herein.

In general, the Character-Level Font Linker begins operation by parsing a text string to be rendered, displayed and/or printed (hereinafter referred to as simply “rendering” or “rendered”) to identify runs of characters that have glyph-level support for all characters in the run with respect to a particular font. Glyph support for particular characters is determined by comparing the Unicode code-point of each character to corresponding entries for the various fonts represented in the lookup table.

In the case where there is a default font (a user specified or preferred font), the Character-Level Font Linker tests that font with respect to the Unicode code-point of the first character of a run (which begins with the first character of the text string) to determine whether that font supports that first character with a glyph. If so, then the Character-Level Font Linker tests the next character, and so on, until a character is found in the text string that is not supported by the current font. Once an unsupported character is identified, the Character-Level Font Linker queries the lookup table to identify a new font that will support that character with a glyph. The newly identified font is then assigned to the current character, which is also used as the beginning of a new run of characters.

In the case where there is no default font, the Character-Level Font Linker simply compares the Unicode code-point of the first character to the lookup table to identify an initial font that includes glyph support for that character. The Character-Level Font Linker then proceeds as summarized above with respect to the subsequent characters in the text string.

In view of the preceding paragraphs, it should be clear that character runs are delimited by examining the characters in the text string relative to the lookup table to find contiguous sets of one or more characters supported by particular fonts that provide a glyph for each character in the run. However, this basic font selection method is further modified in various additional embodiments.

For example, in one embodiment, the lookup includes a default or user assigned font selection priority. This priority is useful since for many Unicode code-points there will be multiple fonts that support a particular glyph. In this case, font selection is achieved by selecting higher priority fonts first when identifying those fonts that support a particular character with an actual glyph.

In various related embodiments, consideration is given to overall uniformity or consistency of the text string to be rendered. For example, while it may be possible to associate many unique fonts to a text string for rendering all of the characters in that text string, the use of a large number of fonts will tend to reduce the overall uniformity of the rendered text. As a result, in various embodiments, the Character-Level Font Linker will automatically reduce the total number of fonts used by selecting the fewest number of fonts possible for rendering the overall text string. To accomplish this embodiment, the Character-Level Font Linker will first identify all of the fonts included in the lookup table that will support each character of the text string, and will then perform a set minimization operation to find the font, or smallest set of fonts, by heuristic rules, such as being uniform in term of font family or style, that will provide glyph support for the characters of the overall text string.

In a related embodiment, the Character-Level Font Linker is limited by a default font (user selected or preferred font), such that all characters supported by that font (according to the lookup table) will be rendered using that font. All of the remaining characters will then be rendered by other fonts by consulting the lookup table, again with the limitation that the total number of fonts used to render the remaining characters is minimized to ensure the greatest overall uniformity of the rendered text.

Once all of the runs have been identified and assigned supporting characters from corresponding fonts, the text string is rendered by using conventional techniques for displaying and/or printing the glyphs corresponding to the characters in the text string by using the fonts assigned to each run of characters.

3.2 System Architectural Overview:

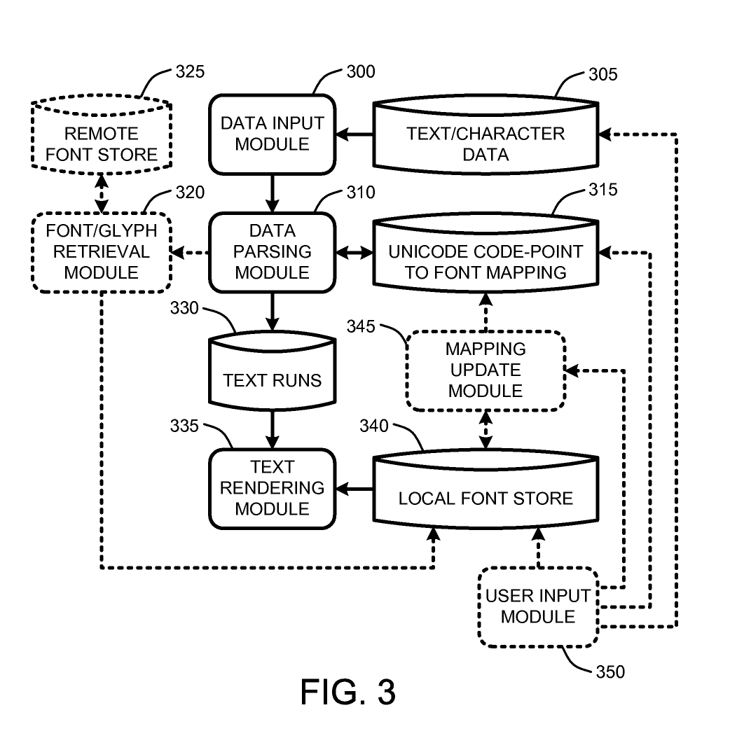

The processes summarized above are illustrated by the general system diagram of FIG. 3. In particular, the system diagram of FIG. 3 illustrates the interrelationships between program modules for implementing the Character-Level Font Linker, as described herein. It should be noted that any boxes and interconnections between boxes that are represented by broken or dashed lines in FIG. 3 represent alternate embodiments of the Character-Level Font Linker described herein, and that any or all of these alternate embodiments, as described below, may be used in combination with other alternate embodiments that are described throughout this document.

In general, as illustrated by FIG. 3, the Character-Level Font Linker generally begins operation by using a data input module 300 to receive a set of text/character data 305 representing one or more text strings. This text data 305 is the provided to a data parsing module 310 that begins a character-level parsing of the text data to identify runs of characters that are supported by a single font. Determination of whether a run of characters is supported by a single font is made by comparing the code-points of successive characters to a Unicode code-point to font mapping table or database 315 (also referred to herein as the “lookup table”).

As noted above, the lookup table 315 indicates, for every locally available font included in the table, which Unicode code-points are actually supported by each of those fonts with actual glyphs. Therefore, given the code-point for every character of the text data 305, the data parsing module is able to construct the text runs 330 that are supported by single fonts by consulting the lookup table 315.

In one embodiment, if the data parsing module 310 is unable to find a local font that provides a glyph for a particular character of the text data 305, the data parsing module calls a font/glyph retrieval module 320 which connects to a remote font store 325 maintained by one or more remote servers. The font/glyph retrieval module 320 provides the code-point of the needed glyph to the remote font store 325, which then returns either an entire font, or an individual glyph that will support the character that is not supported by a local font store 340 as indicated by the lookup table 315. The returned font or individual glyph is then added to the local font store, and a mapping update module 345 updates the lookup table 315 with the character/script support information of the new font or glyph.

In either case, once all of the text runs 330 have been assigned fonts by the data parsing module, those runs are provided to a text rendering module 335 which calls the local font store 340 to render the text data 305 using conventional font rendering techniques.

As noted above, in one embodiment, the local font store 340 can be updated, either by adding or deleting fonts. Such updates can occur automatically because of the actions of some local or remote application, or can occur via manual user action via a user input module 350. In either case, in one embodiment, additions to the local font store 340 trigger the mapping update module 345 to evaluate the newly added fonts to add the character/script support information to the lookup table 315. Similarly, deletions from the local font store 340 trigger the mapping update module 345 to remove the corresponding character/script support information from the lookup table 315.

In another embodiment, the user can trigger updates to the lookup table 315 via the user input module 350 at any time the user desires. In a related embodiment, the user is provided with the capability to manually access and modify the lookup table 315 via the user input module 350. One example of a user modification to the lookup table includes the capability to manually specify the use of one code-point as a substitute for another code-point, either globally, or with respect to one or more particular fonts. The result of such a modification is that the Character-Level Font Linker will automatically cause a user specified glyph to be rendered whenever a particular character is included in the text data 305.

4.0 Operation Overview:

The above-described program modules are employed for implementing the Character-Level Font Linker described herein. As summarized above, this Character-Level Font Linker provides a system and method for ensuring that characters in a text string will be rendered with as few “white boxes” as possible by ensuring that fonts assigned to character runs segmented from a text string provide glyphs for each character in each run. The following sections provide a detailed discussion of the operation of the Character-Level Font Linker, and of exemplary methods for implementing the program modules described in Section 2.

4.1 Operational Details of the Character-Level Font Linker:

The following paragraphs detail specific operational embodiments of the Character-Level Font Linker described herein. In particular, the following paragraphs describe an overview of the lookup table with optional remote font/glyph retrieval; text string parsing; text rendering; and operational flow of the Character-Level Font Linker.

4.2 Unicode Code-Point to Font Mapping Table:

As noted above, the “Unicode Code-Point to Font Mapping Table,” also referred to herein as the “lookup table” provides, for every font included in the table, an indication of which Unicode code-points are actually supported by each font with actual glyphs. In general, the lookup table serves at least two primary purposes: 1) it covers as many Unicode code-points as possible, given a particular set of available fonts; and 2) the use of the lookup table allows the Character-Level Font Linker to use as fonts as possible when rendering a particular text string.

In one embodiment, construction of the lookup table is performed offline (remotely) based on an automatic evaluation of each of a set of default fonts expected to be available to the user. In general, construction of the lookup table involves examining every code-point of each font for each of the scripts nominally supported by that font to determine whether there is an actual glyph for each corresponding code point. Further, in the unlikely case that a particular font fails to indicate support for a particular script (or any script at all) it is possible to examine every possible code-point for the font to determine what characters are actually supported with glyphs. Since construction is performed offline in one embodiment, the fact that there are approximately one-million code-points in the Unicode international standard isn't a significant concern since such computations can be performed once for each font, with the results then being provided to many end users in the form of the lookup table.

As noted above, in various embodiments, the lookup table can also be constructed, updated, or edited locally by individual users. In this case, the lookup table contains the same type of data (actual glyph support for each corresponding code-point for one or more locally available fonts) as the lookup table constructed offline. As discussed above, in one embodiment, the lookup table is user editable via a user interface. Similarly, in various related embodiments, the lookup table is updated whenever one or more fonts are added or deleted from the user's computer system. Such updates are performed either automatically, or upon user request, by automatically evaluating one or more locally available fonts to determine which Unicode code-points are actually supported by each local font with actual glyphs.

Further, also as noted above, in one embodiment, when the Character-Level Font Linker optionally downloads a font or glyph to support a particular character, corresponding updates to the lookup table are performed to indicate local support for that character for use in rendering subsequent text data.

4.3 Text String Parsing:

As discussed above, parsing of the text data or text string involves segmenting that data into a number of “text runs” or “character runs” that are each supported by an individual font. In general, this parsing involves a character level comparison of the text data (as a function of the Unicode code-points associated with each character) to the glyph support information included in the lookup table.

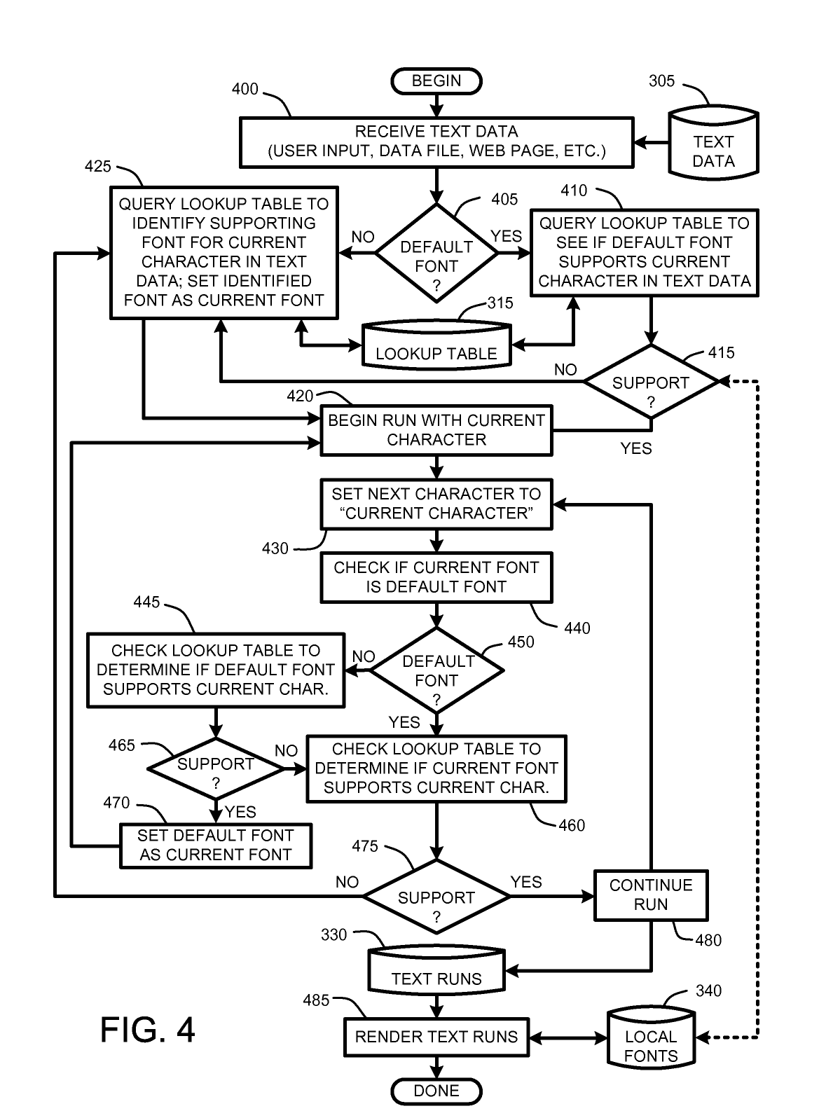

In particular, the Character-Level Font Linker begins this parsing by first identifying a font that supports the first character for the text. If the first character has no font support (according to the lookup table), then the Character-Level Font Linker will examine each succeeding character until a character has font support. The font selected for the current run is referred to as the current font. The Character-Level Font Linker will then terminate the current run at the first subsequent character that is not supported by the current font or that is supported by the default font if the current font is not the default font (See FIG. 4, module 450, default font is a user specified or preferred font in order to follow user preference as much as possible). This unsupported character then becomes the first character in a new character run. At this point, the Character-Level Font Linker begins the new character run by finding a new current font that is identified as supporting the current character. The above-described process then continues until the entire text string or text data has been parsed into a set of character or text runs.

As noted above, the lookup table is consulted to identify a font that supports each particular character (based on the code-point of each character). However, in the case that the lookup table is constructed remotely and provided to a local user, it is possible that the user will not have a particular font that is included in the lookup table. Consequently, in one embodiment, the Character-Level Font Linker will first evaluate the lookup table to identify a font that supports a particular character. The Character-Level Font Linker will then scan the local system (or a list of local fonts) to see if the identified font is actually available. If the identified font is not available, then the Character-Level Font Linker will either 1) reevaluate the lookup table to identify another font followed by another check of the locally available fonts until a match between a supporting font and a locally available font is made, or 2) fetch that font (or part of that font, e.g. one glyph) from a remote store.

Further, as discussed above, in one embodiment, assignment of fonts to particular runs, and thus the particular segmentation of runs from the text data, is performed to minimize the number of fonts used to render the text. Consequently, in this embodiment, runs are not actually delimited until a determination is made as to the smallest set of fonts that can be used, as described above.

4.4 Text Rendering:

As noted above, the Character-Level Font Linker parses a text input into a number of text or character runs, with each run including an assigned font that includes glyph support for each character in each run. Consequently, once this information is available, the Character-Level Font Linker simply renders the text using the assigned font for each run. Rendering of text using assigned fonts (and formatting) is well known to those skilled in the art and will not be described in detail herein.

4.5 Operational Flow of the Character-Level Font Linker:

The processes described above with respect to FIG. 3, in view of the detailed description provided above in Sections 2 through 4, are summarized by the general operational flow diagram of FIG. 4. In general, FIG. 4 illustrates an exemplary operational flow diagram for implementing various embodiments of the Character-Level Font Linker. It should be noted that any boxes that are represented by broken or dashed lines in FIG. 4 represent alternate embodiments of the Character-Level Font Linker, as described herein, and that any or all of these alternate embodiments, as described below, may be used in combination with other alternate embodiments that are described throughout this document.

The Character-Level font linker keeps track of a current font and current character during processing. In general, as illustrated by FIG. 4, the Character-Level Font Linker begins operation by receiving 400 text data 305 from any of a number of text in-put sources, such as, for example, direct user input, data files, Internet web pages, etc., and setting the first character as the current character. Next, if there is a default font (including user specified or preferred fonts) 405, the Character-Level Font Linker queries 410 the lookup table 315 to determine whether the default font supports the first character in the text data. If the default font supports 415 the first character of the text data 305 with a glyph, then the Character-Level Font Linker begins 420 a character run with that first character, and sets the default font as current font.

If there is no default font 405, the Character-Level Font Linker queries 425 the lookup table 315 to identify a supporting font for the first character of the text data 305, sets the identified supporting font as the current font, and begins 420 a text run with that character.

The next character is then set as the current character 430. Then, to process each new current character, there are three basic scenarios:
1) First, if the current font 440 is the default font 450, the steps described above for the initial character are repeated. In particular, if the current font is the default font, the lookup table is queried 460 to determine if that font supports 475 the current character. If there is support 475, then the current text run 330 is continued 480. The next character is then set as the current character 430 and the above described process repeats. However, if the current font 440 is the default font 450, but the default font does not support 475 the current character, the Character-Level Font Linker again queries 425 the lookup table 315 to identify a supporting font for the current character of the text data 305, sets the identified supporting font as the current font, and begins 420 a new text run with that character.
2) In the case that the current font 440 is not the default font 450, the lookup table is queried 445 to determine if the default font supports 465 the current character. If the default font does support 465 the current character, the current font is switched back to default font 470, and a new text run is started 420 with current character.
3) Finally, if the current font 440 is not the default font 450, and the default font does not support 465 the current character, the lookup table is queried 460 to determine if the current font supports 475 the current character. If there is support 475, then the current text run 330 is continued 480. The next character is then set as the current character 430 and the above described process repeats. However, if the current font 440 does not support 475 the current character, the Character-Level Font Linker again queries 425 the lookup table 315 to identify a new supporting font for the current character of the text data 305, sets the identified supporting font as the current font, and begins 420 a new text run with that character.

The above described processes (boxes 425 through 480 of FIG. 4) then continue for each subsequent (next) character (430) until the entire text data 305 has been parsed into text runs 330. Once the text data 305 has been parsed, the Character-Level Font Linker then renders 485 the characters of that text data by using the glyphs corresponding to each character from the local font store 340.

In addition to the embodiments illustrated in FIG. 4, the Character-Level Font Linker is operable with a number of additional embodiments, as described above. For example, as noted above, these additional embodiments include the capability to provide local construction/updating/editing of the lookup table. Another embodiment described above, provides for retrieval of fonts and/or glyphs from a remote server if no local support is available for one or more characters of the text data. Yet another embodiment described above provides automatic minimization of the font set used to render the text data (for maintaining uniformity in the rendered text). Each of these embodiments, and any other embodiments described above, may be used in any combination desired to form hybrid embodiments of the Character-Level Font Linker.

The foregoing description of the Character-Level Font Linker has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the Character-Level Font Linker. It is intended that the scope of the invention be limited not by this detailed description, but rather by the claims appended hereto.

What is claimed is:

1. A system for providing fine granularity font selection for rendering text data, comprising using a computing device to perform steps for:
receiving a text data input;
determining Unicode code-points corresponding to each character of the text data input;
parsing the text data input into a plurality of runs of one or more characters by sequentially comparing the Unicode code-points of each character of the text data input to entries in a lookup table corresponding to a set of one or more fonts;
wherein the lookup table specifically identifies the individual glyphs included in each font relative to the corresponding Unicode code-point of the character corresponding to each glyph;
assigning a font to each run of characters, wherein each character in each run is supported by a corresponding glyph in the assigned font, in accordance with the entries in the lookup table; and
rendering each run of characters using the corresponding glyphs of the assigned font for each run to render the individual characters of each run of characters.

2. The system of claim 1 wherein a default font is given first priority for assignment to each run of characters, such that all characters supported by corresponding glyphs of the default font will be rendered using the default font.

3. The system of claim 2 wherein the default font is user selectable.

4. The system of claim 1 wherein the set of one or more fonts corresponds to a set of commonly available fonts, and wherein a common lookup table is provided to each individual user.

5. The system of claim 1 wherein the set of one or more fonts corresponds to a set of one or more fonts locally available to individual users, and wherein the lookup table is automatically constructed for each individual user by examining glyph-level support of each font of the set of one or more locally available fonts for each individual user.

6. The system of claim 1 further comprising one or more remote server computers for automatically providing any of individual glyphs and fonts to a local user when the lookup table held by the local user indicates that there is no local font support for one or more characters of the text data input of that local user.

7. The system of claim 1 wherein assigning a font to each run of characters comprises identifying and assigning a minimum set of fonts needed to render the entire text data input.

8. A computer readable medium having computer executable instructions for providing automatic font selection for rendering text data, said computer executable instructions comprising:
providing a lookup table defining which Unicode code-points are supported by glyphs for each script nominally supported by each font;
receiving a text data input, said text data input comprising a set of characters having associated Unicode code-points;
comparing the Unicode code-point of each character of the text data input to the code-points defined in the lookup table to identify a specific font for each character of the text data input, such that the font identified for each character of the text data input includes a glyph for the corresponding character; and
rendering each character of the text data input using the corresponding glyphs from the font identified for each character.

9. The computer readable medium of claim 8 wherein providing the lookup table comprises identifying a set of one or more fonts expected to be locally available to a set of one or more users and evaluating that set of fonts to construct a universal lookup table that is provided to each user.

10. The computer readable medium of claim 8 wherein providing the lookup table comprises identifying a set of one or more fonts locally available to each user and locally evaluating the set of fonts for each user to locally construct a custom lookup table for each user.

11. The computer readable medium of claim 8 wherein the lookup includes a font selection priority, such that where one or more fonts includes a glyph for a particular corresponding character, the supporting fonts will be selected in order of priority.

12. The computer readable medium of claim 11 wherein the font selection priority is user configurable.

13. The computer readable medium of claim 8 wherein identifying the specific font for each character of the text data input further comprises performing a set minimization operation to identify a smallest set of fonts that will provide glyph support for the characters of the overall text data input.

14. The computer readable medium of claim 8 further comprising computer-executable instructions for:
retrieving any of individual glyphs and fonts from one or more remote servers when a specific font can not be identified via the code-points defined in the lookup table for any one or more characters of the text data input; and
updating the lookup table with the code-points corresponding to any retrieved glyphs and fonts.

15. A method for ensuring that each character of a text string is supported by a corresponding glyph in one or more fonts selected to render the characters of the text string, comprising:
receiving a text string input, said text string including a plurality of characters each defined by a Unicode code-point falling within a range of code-points defining a Unicode script;
parsing the text string input into a plurality of runs of one or more characters by sequentially comparing the Unicode code-points of each character to corresponding Unicode code-point entries in a lookup table corresponding to a set of one or more fonts;
wherein the lookup table defines, for each Unicode script supported for each of the set of one or more fonts, whether each Unicode code-point for each supported script is also supported by a corresponding glyph;
wherein each run of one or more characters comprises a group of contiguous characters that are assigned the same font because that same font includes a glyph for each corresponding character of the run of one or more characters; and
rendering each run of one or more characters using the corresponding glyph of the assigned font for each run of one or more characters to render the individual characters of each run of one or more characters, thereby rendering the entire text string.

16. The method of claim 15 wherein a universal lookup table is defined relative to a set of one or more fonts expected to be locally available to a set of one or more users.

17. The method of claim 15 wherein the lookup table is locally constructed for each of a plurality of users relative to a set of one or more locally available fonts.

18. The method of claim 15 wherein each font includes an associated priority value, and wherein assigning fonts to each run of characters further comprises assigning fonts on a priority basis where more than one font includes all glyphs for that any of characters.

19. The method of claim 15 wherein the priority values associated with one or more fonts are user adjustable.

20. The method of claim 15 wherein assigning fonts to each run of characters further comprises performing a set minimization process to minimize a total number of fonts used to render the overall text string.
